(19) United States
(12) Patent Application Publication
(10) Pub. No.: US 2022/0411677 A1
(43) Pub. Date: Dec. 29, 2022

(54) REWORKABLE OPTICALLY CLEAR ADHESIVE COMPOSITIONS

(71) Applicant: HEWLETT-PACKARD DEVELOPMENT COMPANY, L.P., SPRING, TX (US)

(72) Inventors: KUAN-TING WU, TAIPEI CITY (TW); HSING-HUNG HSIEH, TAIPEI CITY (TW); HANG YAN YUEN, FORT COLLINS, CO (US)

(21) Appl. No.: 17/777,729

(22) PCT Filed: Dec. 5, 2019
(86) PCT No.: PCT/US2019/064706

§ 371 Date: May 18, 2022

(51) Int. Cl. C09J 131/04; C09J 11/04; B32B 7/12; B32B 37/12

(52) U.S. Cl. CPC C09J 131/04; C09J 11/04; B32B 7/12; B32B 37/1207; C09J 2301/414; C09J 2301/304; C09J 2301/302; C09J 2423/04; C09J 2203/318; B32B 2307/412; B32B 2457/202; B32B 2457/208; B32B 2037/1215; B32B 2037/1269; B32B 2264/301; B32B 2264/1022; B32B 2309/12

(57) ABSTRACT

Described herein is a reworkable optically clear adhesive composition comprising: a hot melt adhesive present in an amount of at least about 40 wt. %; a pressure sensitive adhesive present in an amount of at 5 least about 10 wt. %; and titanium dioxide nanoparticles present in an amount of up to about 5 wt. %; wherein the weight percentage of each component is based on the total weight of solids of the adhesive composition. Also described herein is a display for an electronic device comprising the reworkable optically clear adhesive composition and a method of producing the display for an 10 electronic device.

Displays for electronic devices comprising a light emitting panel (for example, a liquid crystal display panel or a light emitting diode display panel) and an optically clear panel (for example, a protective screen) are assembled using adhesive compositions to adhere the light emitting panel to the optically clear panel. Generally, the adhesive composition is applied between the light emitting panel and the optically clear panel. Such adhesive compositions should not adversely affect the function of the display and should be compatible with the components of the display.

### BRIEF DESCRIPTION OF THE FIGURES

FIG. 1 shows schematically an example display for an electronic device.

FIG. 2 shows schematically another example display for an electronic device.

FIG. 3 shows schematically a further example display for an electronic device.

FIG. 4 shows schematically additional example display for an electronic device.

The figures depict several examples of the present disclosure. It should be understood that the present disclosure is not limited to the examples depicted in the figures.

### DETAILED DESCRIPTION

Before the present disclosure is disclosed and described, it is to be understood that this disclosure is not limited to the particular process details and materials disclosed herein because such process details and materials may vary somewhat. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “co-polymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list just based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

As used herein, the term “reworkable” when used to refer to the optically clear adhesive composition and optically clear adhesive film means that once the said adhesive composition or adhesive film is applied to a substrate it may be removed partially or in its entirety and reapplied without damage to the substrate. The reworkable optically clear adhesive composition and the reworkable optically clear adhesive film can be reworked at a processing temperature, or process temperature range, which may be specific to the composition of the adhesive.

As used herein, the term “processing temperature” is a temperature at which the reworkable optically clear adhesive composition can be heated to make the material malleable enough for it to be removed from the substrate and repositioned onto the substrate without damaging the substrate.

As used herein, the term “substrate” is used to refer to the object to which the reworkable optically clear adhesive composition or the reworkable optically clear adhesive film is applied. The term “substrate” is a general term and is used to encompass specific objects, including, for example, an optically clear panel and a light emitting panel.

As used herein, the term “optically clear” is used to refer to a transmission of 90% or greater as measured in accordance with ASTM 01003 at 550 nm.

Unless otherwise stated, “adhesive composition” used herein refers to “reworkabie optically clear adhesive composition” and “adhesive film” refers to “reworkable optically clear adhesive film”.

As used herein, the term “comprises” has an open meaning, which allows other, unspecified features to be present. This term embraces, but is not limited to, the semi-closed term “consisting essentially of” and the closed term “consisting of”. Unless the context indicates otherwise, the term “comprises” may be replaced with either “consisting essentially of” or “consists of”.

Unless otherwise stated, any feature described herein can be combined with any aspect or any other feature described herein.

There is provided a reworkable optically clear adhesive composition comprising:
a hot melt adhesive present in an amount of at least about 40 wt. %;
a pressure sensitive adhesive present in an amount of at least about 10 wt. %; and
titanium dioxide nanoparticles present in an amount of up to about 5 wt. %;

wherein the weight percentage of each component is based on the total weight of ads of the adhesive composition.

There is provided a display for an electronic device comprising:
an optically clear panel;
a layer of a reworkabie optically clear adhesive composition; and
a light emitting panel;

wherein the reworkabie optically clear adhesive comprises:
a hot melt adhesive present in an amount of at least about 40 wt. %;
a pressure sensitive adhesive present in an amount of at least about 10 wt. %; and
titanium dioxide nanoparticles present in an amount of up to about 5 wt. %;

wherein the weight percentage of each component is based on the total weight of solids of the adhesive composition.

There is provided a method of producing a display for an electronic device comprising:
applying a layer of a reworkabie optically clear adhesive composition to the surface of an optically clear panel and/or the surface of a light emitting panel; and
contacting the optically clear panel and the light emitting panel with the layer of reworkable optically clear adhesive composition therebetween;

wherein the reworkable optically clear adhesive composition comprises:
a hot melt adhesive present in an amount of at least about 40 wt. %;
a pressure sensitive adhesive present in an amount of at least about 10 wt. %; and
titanium dioxide nanoparticles present in an amount of up to about 5 wt. %;

wherein the weight percentage of each component is based on the total weight of solids of the adhesive composition.

Some display screens, in particular antiglare screens and privacy screens, are uncomfortable to view due to visible sparkling of the light emitted by the display screen. Additionally, during assembly of a display screen the layers of the screen may be misaligned, which may necessitate disposal of the entire display. Examples of the reworkable optically clear adhesive composition, display and method of producing the display described herein have been found to avoid or at least mitigate at least one of these difficulties. It has been found that the combined use of a hot melt adhesive, a pressure sensitive adhesive and titanium dioxide nanoparticles provides a display that can be reworked at a suitable temperature (for example, between about 60° C. and 80° C.) and reduces visible sparkling of the display screen.

### Reworkable Optically Clear Adhesive Composition

Described herein is a reworkable optically clear adhesive composition. In some examples, the reworkable optically clear adhesive composition comprises a hot melt adhesive; a pressure sensitive adhesive; and titanium dioxide nanoparticles. The reworkable optically clear adhesive composition may comprise at least about 40 wt. % hot melt adhesive. The reworkable optically clear adhesive composition may comprise at least about 10 wt. % pressure sensitive adhesive. The reworkabie optically clear adhesive composition may comprise up to about 5 wt. % titanium dioxide nanoparticles. The weight percentages of each component are based on the total weight of non-volatile solids of the adhesive composition.

In some examples, the reworkabie optically clear adhesive composition may comprise a hot melt adhesive present in an amount of at least about 40 wt. %; a pressure sensitive adhesive present in an amount of at least about 10 wt. %; and titanium dioxide nanoparticles present in an amount of up to about 5 wt. %; wherein the weight percentage of each component is based on the total weight of solids of the adhesive composition.

In some examples, the reworkable optically clear adhesive composition is reworkable at a temperature below the temperature at which other components of the display (such as the light emitting panel or the optically clear panel) are damaged. In some examples, the reworkable optically clear adhesive composition is not reworkable at room temperature, for example, 25° C. In some examples, the reworkable optically clear adhesive composition is reworkable at a temperature above room temperature but below the temperature at which other components of the display are damaged. In some examples, the reworkable optically clear adhesive composition is reworkable at a temperature of about 80° C. or less, for example, about 79° C. or less, about 78° C. or less, about 77° C. or less, about 76° C. or less, about 75° C. or less, about 74° C. or less, about 73° C. or less, about 72° C. or less, about 71° C. or less, about 70° C. or less, about 69° C. or less, about 68° C. or less, about 67° C. or less, about 66° C. or less, about 65° C. or less, about 64° C. or less, about 63° C. or less, about 62° C. or less, about 61° C. or less, or about 60° C. in some examples, the reworkable optically clear adhesive composition is reworkable at a temperature of about 60° C. or more, for example, about 61° C. or more, about 62° C. or more, about 63° C. or more, about 64° C. or more, about 65° C. or more, about 66° C. or more, about 67° C. or more, about 68° C. or more, about 69° C. or more, about 70° C. or more, about 71° C. or more, about 72° C. or more, about 73° C. or more, about 74° C. or more, about 75° C. or more, about 76° C. or more, about 77° C. or more, about 78° C. or more, about 79° C. or more, or about 80° C. or more. In some examples, the reworkable optically clear adhesive composition is reworkable at a temperature in the range of from about 60° C. to about 80° C., for example, about 61° C. to about 80° C., about 62° C. to about 79° C., about 63° C. to about 78° C., about 64° C. to about 77° C., about 65° C. to about 76° C. about 66° C. to about 75° C., about 67° C. to about 74° C., about 68° C. to about 73° C., about 69° C. to about 72° C., or about 76° C. to about 71° C. The temperature or temperature range at which the composition is reworkable is the temperature or temperature range at which the reworkabie optically clear adhesive composition is malleable enough for it to be removed from the substrate and repositioned onto the substrate without damaging the substrate. In this way the application of the reworkable optically clear adhesive composition onto the substrate can be corrected to remove, for example, any misalignment of substrates. Additionally, the readjustment of the adhesive composition may allow any air bubbles formed between the adhesive composition and the substrate to be removed. Application of the adhesive composition in this way allows any errors in the alignment of substrates to be removed. This temperature may be referred to as the processing temperature. A processing temperature of no more than 80° C. also allows the adhesive composition to be used on substrates that do not tolerate higher temperatures.

In some examples, the reworkable optically clear adhesive composition may further comprise a solvent. In some examples, the reworkable optically clear adhesive composition may comprise a hot melt adhesive, a pressure sensitive adhesive, titanium dioxide nanoparticles, and a solvent.

In some examples, the reworkable optically clear adhesive composition may further comprise additives. In some examples, the reworkable optically clear adhesive composition may comprise a hot melt adhesive, a pressure sensitive adhesive, titanium dioxide nanoparticles and additives. In some examples, the reworkable optically clear adhesive composition may comprise a hot melt adhesive, a pressure sensitive adhesive, titanium dioxide nanoparticles, a solvent and additives.

### Titanium Dioxide Nanoparticfes

The reworkable optically clear adhesive composition may comprise up to about 5 wt. % titanium dioxide nanoparticles, for example, up to about 4.5 wt. %, up to about 4 wt. %, up to about 3.5 wt. %, up to about 3 wt. %, up to about 2.5 wt. %, up to about 2 wt. %, up to about 1 wt. %, up to about 0.5 wt. % titanium dioxide nanoparticles. In some examples, the reworkable optically clear adhesive composition may comprise about 0.1 wt. % or more titanium dioxide nanoparticles, for example, about 0.2 wt. % or more, about 0.3 wt. % or more, about 0.4 wt. % or more, about 0.5 wt. % or more, about 0.6 wt. % or more, about 0.7 wt. % or more, about 0.8 wt. % or more, about 0.9 wt. % or more, about 1 wt. % or more, about 1.5 wt. % or more, about 2 wt. % or more, about 2.5 wt. % or more, about 3 wt. % or more, about 3.5 wt. % or more, about 4 wt. % or more, or about 4.5 wt. % or more titanium dioxide nanoparticles. In some examples, the reworkable optically clear adhesive composition may comprise from about 0.1 to about 5 wt. % titanium dioxide nanoparticles, for example, from about 0.2 wt. % to about 5 wt. %, about 0.3 wt. % to about 4.5 wt. %, about 0.4 wt. % to about 4 wt. %, about 0.5 wt. % to about 3.5 wt. %, about 0.6 wt. % to about 3 wt. %, about 0.7 wt. % to about 2.5 wt. %, about 0.8 wt. % to about 2 wt. %, about 0.9 wt. % to about 1.5 wt. %, about 1 wt. % to about 3 wt. % titanium dioxide nanoparticies. The weight percentage of titanium dioxide nanoparticles is based on the total weight of non-volatile solids of the adhesive composition.

In some examples, the titanium dioxide nanoparticles may have an average particle size of about 1 μm or less, for example, about 900 nm or less, 750 nm or less, about 500 nm or less, about 250 nm or less, about 100 nm or less, about 50 nm or less, 10 nm or less, or about 1 nm or less. In some examples, the titanium dioxide nanoparticles may have an average particle size of at least about 1 nm, for example, at least about 10 nm, at least about 50 nm, at least about 100 nm, at least about 250 nm, at least about 500 nm or more, at least about 750 nm, at least about 900 nm, about 1 μm. In some examples, the titanium dioxide nanoparticles may have an average particle size of from about 1 nm to about 1 μm, for example, from about 10 nm to about 900 nm, about 50 nm to about 750 nm, about 100 nm to about 500 nm, or about 1 nm to about 250 nm. The average particle size is measured by laser diffraction and therefore is the volume-based average particle size. In some examples, the average particle size is measured in accordance with ASTM D4464-15, by using, for example, a Malvern Mastersizer 3000.

### Hot Melt Adhesive

Hot melt adhesives are thermoplastic in nature and are solid at room temperature. Generally, hot melt adhesives are non-tacky at room temperature but become tacky and capable of bonding to a substrate at elevated temperatures.

The reworkable optically clear adhesive composition may comprise a hot melt adhesive present in an amount of at least about 40 wt. % by total weight of the non-volatile solids of the reworkable optically clear adhesive composition. In some examples, the reworkable optically clear adhesive composition may comprise a hot melt adhesive in an amount of at least about 45 wt. % by total weight of the non-volatile solids of the reworkable optically clear adhesive composition, for example, at least about 50 wt. %, at least about 55 wt. %, at least about 60 wt. %, at least about 65 wt. %, at least about 66 wt. %, at least about 70 wt. %, at least about 75 wt. %, at least about 80 wt. %, at least about 85 wt. %, at least about 90 wt. % of the reworkable optically clear adhesive composition. In some examples, the reworkable optically clear adhesive composition may comprise a hot melt adhesive in an amount of less than about 90 wt. %, for example, about 85 wt. % or less, about 80 wt. % or less, about 75 wt. % or less, about 70 wt. % or less, about 66 wt. % or less, about 65 wt. % or less, about 60 wt. % or less, about 55 wt. % or less, about 50 wt. % or less, about 45 wt. % or less, or about 40 wt. %. In some examples, the reworkable optically clear adhesive composition may comprise a hot melt adhesive in an amount of from about 40 wt. % to about 90 wt. % of the total weight of the non-volatile solids of the reworkable optically clear adhesive composition, for example, about 45 wt. % to about 90 wt. %, about 50 wt. % to about 85 wt. %, about 55 wt. % to about 80 wt. %, about 60 wt. % to about 75 wt. %, or about 65 wt. % to about 70 wt. % of the total weight of the non-volatile solids of the reworkable optically clear adhesive composition.

In some examples, the hot melt adhesive may be any suitable thermoplastic polymer. In some example, the hot melt adhesive may be any thermoplastic polymer that becomes malleable enough to be removed from a substrate and repositioned onto the substrate at the reworking temperature of the reworkable optically clear adhesive composition.

In some examples, the hot melt adhesive is selected from ethylene vinyl acetate, polypropylene, polyamide, polyurethane and combinations thereof. In some examples, the polyurethane comprises a copolymer of a polyisocyanate and a polyol, for example, a copolymer of a diisocyanate and a diol.

In some examples, the hot melt adhesive, for example, the polyurethane hot melt adhesive, has a weight average molecular weight of from about 2000 to 6000 g/mol.

### Pressure Sensitive Adhesive

Pressure sensitive adhesives are viscoelastic materials that adhere instantaneously to most substrates with the application of slight pressure (e.g., a pressure of from about 15 kg/cm² to about 30 kg/cm²]), remain permanently tacky and have sufficient cohesive strength to be cleanly removed from a substrate.

The reworkable optically clear adhesive composition may comprise a pressure sensitive adhesive present in an amount of at least about 10 wt. % by total weight of the non-volatile solids of the reworkable optically clear adhesive composition. In some examples, the reworkable optically clear adhesive composition may comprise a pressure sensitive adhesive in an amount of at least about 15 wt. %, for example, at least about 20 wt. %, at least about 25 wt. %, at least about 30 wt. %, at least about 33 wt. %, at least about 35 wt. %, at least about 40 wt. %, at least about 45 wt. %, at least about 50 wt. %, at least about 55 wt. %, or about 60 wt. % of the total weight of the non-volatile solids of the reworkable optically clear adhesive composition. In some examples, the reworkable optically clear adhesive composition may comprise a pressure sensitive adhesive in an amount of about 60 wt. % or less, about 55 wt. % or less, about 50 wt. % or less, about 45 wt. % or less, about 40 wt. % or less, about 35 wt. % or less, about 33 wt. % or less, about 30 wt. % or less, about 25 wt. % or less, about 20 wt. % or less, about 15 wt. % or less, or about 10 wt. % by total weight of the non-volatile solids of the reworkable optically clear adhesive composition. In some examples, the reworkable optically clear adhesive composition may comprise a pressure sensitive adhesive in an amount of from about 10 wt. % to about 60 wt. %, for example, about 15 wt. % to about 60 wt. %, about 20 wt. % to about 55 wt. %, about 25 wt. % to about 50 wt. %, about 30 wt. % to about 45 wt. %, or about 35 wt. % to about 40 wt. % of the total weight of the non-volatile solids of the reworkable optically clear adhesive composition.

In some examples, the pressure sensitive adhesive may be any suitable pressure sensitive adhesive. In some examples, the pressure sensitive adhesive is selected from acrylic-based adhesives, natural rubber-based adhesives, styrene-butadiene rubber based adhesives, styrenic block copolymer based adhesives, silicone-based adhesives, epoxy adhesives, polyurethane acrylate adhesives and combinations thereof. In some examples, the polyurethane acrylate comprises a blend of polyurethane and isodecyl acrylate, which may be formed at 40° C. to 65° C. In some examples, the polyurethane acrylate is a copolymer of a polyisocyanate comprising acrylate functionality (e.g., a diisocyanate comprising acrylate functionality) and a polyol (e.g., a dial) or a copolymer of a polyisocyanate (e.g., a diisocyanate) and a polyol comprising acrylate functionality (e.g., a dial comprising acrylate functionality).

In some examples, the pressure sensitive adhesive, for example, the polyurethane acrylate pressure sensitive adhesive, has a weight average molecular weight of from about 2000 to 12000 g/mol.

In some examples, the reworkabie optically clear adhesive composition may comprise any ratio of the hot melt adhesive to the pressure sensitive adhesive. In some examples, the reworkable optically clear adhesive composition may comprise a weight ratio of the hot melt adhesive to the pressure sensitive adhesive is from about 2:3 to about 9:1, for example, from about 1:1 to about 4:1, from about 3:2 to about 7:3, or about 2:1.

### Solvent

In some examples, the reworkable optically clear adhesive composition may further comprise a solvent. In some examples, the solvent may be any solvent capable of dissolving the hot melt adhesive and the pressure sensitive adhesive and dispersing the titanium dioxide nanoparticles.

In some examples, the solvent may be an organic solvent. In some examples, the solvent may be selected from methyl ethyl ketone, methyl isobutyl ketone, 3-methoxy-3-methyl-1-butyl acetate, ethyl acetate, and butyl acetate.

In some examples, the reworkable optically clear adhesive composition may comprise at least about 10 wt. % solvent, for example, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, or at least about 20 wt. %, at least about 25 wt. %, at least about 30 wt. %, at least about 35 wt. %, at least about 39 wt. %, at least about 40 wt. %, at least about 45 wt. %, at least about 50 wt. %, at least about 55 wt. % solvent. In some examples, the reworkable optically clear adhesive composition may comprise about 55 wt. % or less solvent, for example, about 50 wt. % or less, about 45 wt. % or less, about 40 wt. % or less, about 39 wt. % or less, about 35 wt. % or less, about 30 wt. % or less, about 25 wt. % or less, about 20 wt. % or less, about 19 wt. % or less, about 18 wt. % or less, about 17 wt. % or less, about 16 wt. % or less, about 15 wt. % or less, about 14 wt. % or less, about 13 wt. % or less, about 12 wt. % or less, about 11 wt. % or less, or about 10 wt. % or less solvent. In some examples, the reworkable optically clear adhesive composition may comprise from about 10 wt. % to about 55 wt. % solvent, for example, about 11 wt. % to about 50 wt. %, about 12 wt. % to about 45 wt. %, about 13 wt. % to about 40 wt. %, about 14 wt. % to about 35 wt. %, about 15 wt % to about 30 wt. %, about 16 wt. % to about 25 wt. %, about 17 wt. % to about 20 wt. %, about 18 wt. % to about 19 wt. % solvent.

### Additives

In some examples, the reworkable optically clear adhesive composition may further comprise additives or a plurality of additives. In some examples, the additives may comprise up to 10 wt. % of the total non-volatile solids of the reworkable optically clear adhesive composition. In some examples, the additives of plurality of additives may be added at any stage of the method of producing the reworkable optically clear adhesive composition.

In some examples, the additive or plurality of additives may be selected from biocides, surfactants and thickeners.

In some examples, the reworkable optically clear adhesive composition may comprise a biocide in an amount of, for example, about 0.1 wt. % to about 0.3 wt. % of the non-volatile solids, in some examples, about 0.2 wt. % NVS. In some examples, the biocide may be selected from 2-mercaptobenzothiazole and glutaraldehyde.

In some examples, the reworkable optically clear adhesive composition may comprise a surfactant in an amount of, for example, about 0.1 wt. % to about 0.5 wt. % of the non-volatile solids, in some examples, about 0.3 wt. % NVS. In some examples, the surfactant may be selected from sodium caseinate, sodium polyacrylate, sodium polyoxyethylene alkyl ether carboxylate, and sodium dodecyl sulfate.

In some examples, the reworkable optically clear adhesive composition may comprise a thickener in an amount of, for example, about 0.3 wt. % to about 0.8 wt. % of the non-volatile solids, in some examples, about 0.5 wt. % NVS. In some examples, the thickener may be polymethylmethacrylate.

### Display for an Electronic Device

Described herein is a display for an electronic device. The display for an electronic device may comprise an optically clear panel; a layer of a reworkable optically clear adhesive composition; and a light emitting panel. In some examples, the reworkable optically clear adhesive comprises a hot melt adhesive; a pressure sensitive adhesive; and titanium dioxide nanoparticles. In some examples, the reworkabie optically clear adhesive composition may be any reworkable optically clear adhesive composition described herein.

In some examples, the reworkable optically clear adhesive composition adheres the light emitting panel to the optically clear panel.

In some examples, the light emitting panel comprises a liquid crystal display panel or a light emitting diode display panel.

In some examples, a liquid crystal display panel comprises a layer of liquid crystal disposed between two polarizers, wherein the two polarizers are disposed such that the direction of polarization of each polarizer is perpendicular to the direction of polarization of the other. In some examples, a liquid crystal display panel comprises a light source; a first piece of polarized glass; a nematic liquid crystal disposed on the first piece of polarized glass; and a second piece of polarized glass disposed on the nematic liquid crystal. The first piece of polarized glass has a first direction of polarization and the surface of the first piece of polarized glass in contact with the nematic liquid crystal comprises microscopic grooves that are parallel to the first direction of polarization. The second piece of polarized glass has a second direction of polarization that is perpendicular to the first direction of polarization and the surface of the second piece of polarized glass in contact with the nematic liquid crystal comprises microscopic grooves that are parallel to the second direction of polarization and therefore perpendicular to the first direction of polarization. The layer of molecules in contact with the microscopic grooves of each piece of polarized glass align with the orientation of the microscopic grooves such that the orientation of the molecules in the liquid crystal twists across its thickness. As polarized light passes through the liquid crystal, the direction of polarization is altered by the orientation of the molecules in the liquid crystal, causing a 90° rotation in direction of polarization and allowing the light to pass through the second polarizer. When an electric charge is applied across the liquid crystal display, the orientation of the molecules of the liquid crystal is changed, such that the direction of polarization of the light does not match the direction of polarization of the second polarizer, resulting in no emission of light. In some examples, the light source may be a light emitting diode or an array of light emitting diodes. In some examples, the liquid crystal display may further comprise a colour filter.

In some examples, the light emitting diode display panel may comprise an array of individually controllable light emitting diodes, for example, organic light emitting diodes, such that each individual light emitting diode forms a pixel of the display.

In some examples, the display may comprise a touchscreen. In some examples, the touchscreen may be disposed between the optically clear panel and the light emitting panel. In some examples, the optically clear panel comprises the touchscreen. In some examples, the light emitting panel comprises the touchscreen.

In some examples, the optically clear panel comprises a touchscreen, a protective panel or a combination thereof.

In some examples, the optically clear panel comprises a protective panel. In some examples, the optically clear panel comprises a touchscreen and a protective panel. In some examples, the display comprises a protective panel, a touchscreen and a light emitting panel, wherein the touchscreen is disposed between the protective panel and the light emitting panel.

In some examples, the optically clear panel is adhered to the light emitting panel by the reworkable optically clear adhesive. In some examples, the display comprises a protective panel, a touchscreen, and a light emitting panel, wherein the protective panel is in contact with the touchscreen and the touchscreen is adhered to the light emitting panel by the reworkabie optically clear adhesive. In some examples, the display comprises a protective panel, a touchscreen, and a light emitting panel, wherein the protective panel is adhered to the touchscreen by the reworkable optically clear adhesive and the touchscreen is in contact with the light emitting panel. In some examples, the display comprises a protective panel, a touchscreen, and a light emitting panel, wherein the protective panel is adhered to the touchscreen by an adhesive and the touchscreen is adhered to the light emitting panel by the reworkable optically clear adhesive. In some examples, the display comprises a protective panel, a touchscreen, and a light emitting panel, wherein the protective panel is adhered to the touchscreen by the reworkable optically clear adhesive and the touchscreen is adhered to the light emitting panel by an adhesive. In some examples, the display comprises a protective panel, a touchscreen, and a light emitting panel, wherein the protective panel is adhered to the touchscreen by the reworkable optically clear adhesive and the touchscreen is adhered to the light emitting panel by the reworkable optically clear adhesive.

In some examples, the protective panel may comprise a glass pane or an optically clear plastic panel. In some examples, the protective panel may comprise glass (e.g., borosilicate glass, alkali-aluminosilicate class, soda-lime glass, alkali-barium silicate glass) or plastic (e.g., polyacrylic, polycarbonate, polyacrylic/polycarbonate composite, and cyclic olefin copolymer).

A touchscreen may comprise a touch responsive surface. In some examples, the touchscreen may comprise polyester, polyacrylic, polycarbonate, or a cyclic olefin copolymer.

In some examples, the layer of reworkable optically clear adhesive may have a thickness of about 10 μm or more, for example, about 15 μm or more, about 20 μm or more, about 25 μm or more, about 30 μm or more, about 35 μm or more, about 40 μm or more, about 45 μm or more, about 50 μm or more, about 55 μm or more, or about 60 μm or more. In some examples, the layer of reworkable optically clear adhesive may have a thickness of about 60 μm or less, for example, about 55 μm or less, about 50 μm or less, about 45 μm or less, about 40 μm or less, about 35 μm or less, about 30 μm or less, about 25 μm or less, about 20 μm or less, about 15 μm or less, or about 10 μm or less. In some examples, the layer of reworkable optically clear adhesive may have a thickness of about 10 μm to about 60 μm, for example, about 15 μm to about 60 μm, about 20 μm to about 55 μm, about 25 μm to about 50 μm, about 30 μm to about 45 μm, or about 35 μm to about 40 μm. In some examples, the layer of reworkable optically clear adhesive extends across the entire surface area of the optically clear panel and the light emitting panel.

In some examples, the electronic device may be a computer (e.g., a desktop computer, a laptop computer, a tablet computer, etc.), a monitor (e.g., for a desktop computer, a mobile phone, a television, a watch or other electronic device.

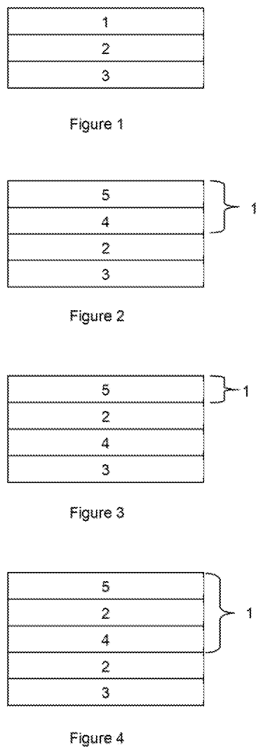

FIG. 1 schematically depicts a display for an electronic device comprising an optically clear panel (1) and a light emitting device (3). A layer of reworkable optically clear adhesive (2) adheres the optically clear panel (1) to the light emitting device (3). The optically clear panel (1) may be a touchscreen or a protective panel.

FIG. 2 schematically depicts a display for an electronic device comprising an optically clear panel (1) that comprises a touchscreen (4) and a protective panel (5). The touchscreen (4) and the protective panel (5) may be adhered together with an optically clear adhesive, which may or may not be a reworkable optically clear adhesive as described herein. In some examples, the touchscreen (4) is adhered to the protective panel (5) by a reworkable optically clear adhesive.

FIG. 3 schematically depicts a display for an electronic device wherein the optically clear panel (1) is a protective panel (5) and a touchscreen (4) is disposed between the layer of reworkable optically clear adhesive (2) and the light emitting panel (3).

FIG. 4 schematically depicts a display for an electronic device wherein the optically clear panel (1) comprises a touchscreen (4) and a protective panel (5) and wherein the touchscreen (4) is adhered to the protective panel (5) by a layer of reworkable optically clear adhesive (2).

### Method of Producing a Reworkable Optically Clear Adhesive Composition

A reworkable optically clear adhesive composition may be prepared by combining a hot melt adhesive, a pressure sensitive adhesive and titanium dioxide nanoparticles. In some examples, a reworkable optically clear adhesive composition may be prepared by blending together a hot melt adhesive, a pressure sensitive adhesive and titanium dioxide nanoparticles.

In some examples, a reworkable optically clear adhesive composition may be prepared by blending together a hot melt adhesive, a pressure sensitive adhesive and titanium dioxide nanoparticles in the presence of a solvent.

In some examples, the reworkable optically clear adhesive composition may be prepared by blending together a hot melt adhesive, a pressure sensitive adhesive and titanium dioxide nanoparticles (optionally in the presence of a solvent) at a raised temperature. In some examples, the raised temperature may be a temperature of at least about 60° C., for example, at least about 61° C., at least about 62° C., at least about 63° C., at least about 64° C., at least about 65° C., at least about 66° C., at least about 67° C., at least about 68° C., at least about 69° C., at least about 70° C., at least about 71° C., at least about 72° C., at least about 73° C., at least about 74° C., at least about 75° C., at least about 76° C., at least about 77° C., at least about 78° C., at least about 79° C., or at least about 80° C. In some examples, the raised temperature may be a temperature of about 80° C. or less, for example, about 79° C. or less, about 78° C. or less, about 77° C. or less, about 76° C. or less, about 75° C. or less, about 74° C. or less, about 73° C. or less, about 72° C. or less, about 71° C. or less, about 70° C. or less, about 69° C. or less, about 68° C. or less, about 67° C. or less, about 66° C. or less, about 65° C. or less, about 64° C. or less, about 63° C. or less, about 62° C. or less, about 61° C. or less, or about 60° C. or less. In same examples, the raised temperature may be a temperature of about 60° C. to about 80° C., for example, about 61° C. to about 80° C., about 62° C. to about 79° C., about 63° C. to about 78° C., about 64° C. to about 77° C., about 65° C. to about 76° C., about 66° C. to about 75° C., about 67° C. to about 74° C., about 68° C. to about 73° C., about 69° C. to about 72° C., or about 70° C. to about 71° C.

In some examples, blending comprises mixing at a shear rate of about 3000 rpm or more, for example, about 3100 rpm or more, about 3200 rpm or more, about 3300 rpm or more, about 3400 rpm or more, or about 3500 rpm or more. In some examples, blending comprises mixing at a shear rate of about 3500 rpm or less, for example, about 3400 rpm or less, about 3300 rpm or less, about 3200 rpm or less, about 3100 rpm or less, or about 3000 rpm. In some examples, blending comprises mixing at a shear rate of about 3000 rpm to about 3500 rpm, for example, about 3100 rpm to about 3400 rpm or about 3100 rpm to about 3300 rpm.

In some examples, the reworkable optically clear adhesive composition may be coated on a release layer to form an adhesive tape or an adhesive film. In some examples, a second release layer may be applied to the exposed surface of the reworkable optically clear adhesive composition. In some examples, the solvent is evaporated from the reworkable optically clear adhesive composition to form the adhesive tape or adhesive film. In some examples, the solvent is evaporated by heating to a raised temperature. In some examples, the raised temperature is about 60° C. or more, for example, about 65° C. or more, about 70° C. or more, about 75° C. or more, about 80° C. or more. In some examples, the raised temperature is about 80° C. or less, for example, about 75° C. or less, about 70° C. or less, about 65° C. or less, about 60° C. or less. In some examples, the raised temperature is from about 60° C. to about 80° C., for example, about 65° C. to about 80° C., or about 70° C. to about 75° C.

### Method of Producing a Display for Art Electronicdevice

Described herein is a method of producing a display for an electronic device. The method of producing a display for an electronic device may comprise applying a layer of a reworkable optically clear adhesive composition to the surface of an optically clear panel and/or the surface of a light emitting panel; and contacting the optically clear panel and the light emitting panel with the layer of reworkable optically clear adhesive composition therebetween. The reworkable optically clear adhesive composition may comprise a hot melt adhesive; a pressure sensitive adhesive; and titanium dioxide nanoparticles.

The method of producing a display for an electronic device may comprise applying a layer of a reworkable optically clear adhesive composition to the surface of a first substrate (wherein the first substrate may be the optically clear panel or the light emitting panel); and contacting the first substrate with a second substrate with the layer of optically clear adhesive composition therebetween (wherein the second substrate is different from the first substrate and may be the optically clear panel or the light emitting panel).

In some examples, the layer of reworkable optically clear adhesive may be applied as a liquid. In some examples, the reworkable optically clear adhesive is applied by gravure coating, calendering, rod coating, flexo coating, screen coating, spray coating, roll coating, reverse roll coating, gap coating, slot die coating, immersion coating, curtain coating, air knife coating, flood coating, lithography, inkjet printing or a combination thereof.

In some examples, the reworkable optically clear adhesive composition is a liquid due to the presence of a solvent. In some examples, after the layer of reworkable optically clear adhesive is applied, the solvent is removed, for example, by evaporation. In some examples, the solvent is evaporated from the layer of reworkable optically clear adhesive composition by heating to a raised temperature. In some examples, the raised temperature is about 60° C. or more, for example, about 65° C. or more, about 70° C. or more, about 75° C. or more, about 80° C. or more. In some examples, the raised temperature is about 80° C. or less, for example, about 75° C. or less, about 70° C. or less, about 65° C. or less, about 60° C. or less. In some examples, the raised temperature is from about 60° C. to about 80° C., for example, about 65° C. to about 80° C., or about 70° C. to about 75° C.

In some examples, the reworkable optically clear adhesive composition may be applied at a raised temperature. In some examples, the raised temperature is about 60° C. or more, for example, about 65° C. or more, about 70° C. or more, about 75° C. or more, about 80° C. or more. In some examples, the raised temperature is about 80° C. or less, for example, about 75° C. or less, about 70° C. or less, about 65° C. or less, about 60° C. or less. In some examples, the raised temperature is from about 60° C. to about 80° C., for example, about 65° C. to about 80° C., or about 70° C. to about 75° C.

In some examples, the layer of reworkable optically clear adhesive may be applied as a solid, for example, in the form of an adhesive tape. In some examples, prior to application, the adhesive tape may comprise a release layer on one or both surfaces of the adhesive tape. The release layer is removed before the adhesive tape is applied.

In some examples, the layer of reworkable optically clear adhesive may be applied as a solid, for example, in the form of an adhesive film. In some examples, prior to application, the adhesive film may comprise a release layer on one or both surfaces of the adhesive film. The release layer is removed before the adhesive film is applied.

In some examples, the reworkable optically clear adhesive is applied to the substrate, forming an adhesive layer on the substrate. In some examples, the adhesive layer may have a thickness of about 10 μm or more, for example, about 15 μm or more, about 20 μm or more, about 25 μm or more, about 30 μm or more, about 35 μm or more, about 40 μm or more, about 45 μm or more, about 50 μm or more, about 55 μm or more, or about 60 μm or more. In some examples, the adhesive layer may have a thickness of about 60 μm or less, for example, about 55 μm or less, about 50 μm or less, about 45 μm or less, about 40 μm or less, about 35 μm or less, about 30 μm or less, about 25 μm or less, about 20 μm or less, about 15 μm or less, or about 10 μm or less. In some examples, the adhesive layer may have a thickness of about 10 μm to about 60 μm, for example, about 15 μm to about 60 μm, about 20 μm to about 55 μm, about 25 μm to about 50 μm, about 30 μm to about 45 μm, or about 35 μm to about 40 μm.

In some examples, the method of producing a display for an electronic device comprises applying a layer of the reworkable optically clear adhesive composition to the surface of the optically clear panel and contacting the layer of the reworkable optically clear adhesive with a surface of the light emitting panel.

In some examples, the method of producing a display for an electronic device comprises applying a layer of the reworkable optically clear adhesive composition to the surface of the light emitting panel and contacting the layer of the reworkable optically clear adhesive with a surface of the optically clear panel.

In some examples, the method of producing a display for an electronic device comprises applying a layer of the reworkable optically clear adhesive composition to the surface of the optically clear panel; applying a layer of the reworkable optically clear adhesive composition to the surface of the light emitting panel; and contacting the optically clear panel and the light emitting panel with the reworkable optically clear adhesive composition disposed between the optically clear panel and the light emitting panel.

In some examples, the method of producing a display for an electronic device comprises applying a layer of the reworkable optically clear adhesive composition to a touchscreen and/or a light emitting panel; and contacting the touchscreen and the light emitting panel with the layer of reworkable optically clear adhesive composition therebetween. In some examples, the method of producing a display for an electronic device comprises applying a layer of the reworkable optically clear adhesive composition to a touchscreen and contacting the layer of the reworkable optically clear adhesive composition with a light emitting panel. In some examples, the method of producing a display for an electronic device comprises applying a layer of the reworkable optically clear adhesive composition to a light emitting device and contacting the layer of reworkable optically clear adhesive composition with a touchscreen. In some examples, the method of producing a display for an electronic device comprise applying a layer of the reworkable optically clear adhesive composition to a touchscreen; applying a layer of reworkable optically clear adhesive composition to a light emitting panel; and contacting the touchscreen with the light emitting panel with the layer of reworkable optically clear adhesive therebetween.

In some examples, the optically clear panel comprises a touchscreen and a protective panel and the method of producing the display for an electronic device comprises applying a layer of a reworkable optically clear adhesive composition to the surface of the touchscreen and/or the surface of a light emitting panel; and contacting the touchscreen with the light emitting panel with the layer of reworkable optically clear adhesive therebetween. In some examples, the optically clear panel comprises a touchscreen and a protective panel and the method of producing the display for an electronic device comprises applying a layer of a reworkable optically clear adhesive composition to the surface of the touchscreen; and contacting the layer of reworkable optically clear adhesive with the light emitting panel. In some examples, the optically clear panel comprise a touchscreen and a protective panel and the method of producing the display for an electronic device comprises applying a layer of a reworkable optically clear adhesive composition to the surface of the light emitting panel and contacting the layer of reworkable optically clear adhesive with the touchscreen.

In some examples, a touchscreen is disposed between the layer of reworkable optically clear adhesive composition and the light emitting panel and the method of producing the display for an electronic device comprises applying a layer of reworkable optically clear adhesive to the surface of the optically clear panel and/or the touchscreen and contacting the touchscreen with the optically clear panel with the layer of reworkable optically clear adhesive therebetween. In some examples, a touchscreen is disposed between the layer of reworkable optically clear adhesive composition and the light emitting panel and the method of producing the display for an electronic device comprises applying a layer of reworkable optically clear adhesive to the surface of the optically clear panel and contacting the touchscreen with the layer of reworkable optically clear adhesive composition. In some examples, a touchscreen is disposed between the layer of reworkable optically clear adhesive composition and the light emitting panel and the method of producing the display for an electronic device comprises applying a layer of reworkable optically clear adhesive to the surface of the touchscreen and contacting the optically clear panel with the layer of reworkable optically clear adhesive composition. In some examples, a touchscreen is disposed between the layer of reworkable optically clear adhesive composition and the light emitting panel and the method of producing the display for an electronic device comprises applying a layer of reworkable optically clear adhesive composition to the surface of the optically clear panel; applying a layer of reworkable optically clear adhesive composition to the touchscreen and contacting the touchscreen with the optically clear panel with the layer of reworkable optically clear adhesive therebetween.

The method of producing a display for an electronic device may comprise applying a layer of a reworkable optically clear adhesive composition to the surface of a light emitting panel; contacting the layer of reworkable optically clear adhesive composition with a touchscreen; applying a layer of reworkable optically clear adhesive composition to the touchscreen and contacting a protective panel with the layer of reworkable optically clear adhesive composition. The method of producing a display for an electronic device may comprise applying a layer of a reworkable optically clear adhesive composition to the surface of a protective panel, contacting the layer of reworkable optically clear adhesive composition with a touchscreen; applying a layer of a reworkable optically clear adhesive composition to the touchscreen and contacting a light emitting panel with the layer of reworkable optically clear adhesive composition. The method of producing a display for an electronic device may comprise contacting a reworkable optically clear adhesive composition with a touchscreen; contacting the layer of optically clear adhesive composition with a protective panel; applying a layer of reworkable optically clear adhesive composition to the touchscreen and contacting a light emitting panel with the layer of reworkable optically clear adhesive composition.

In some examples, the reworkable optically clear adhesive may be applied at a raised temperature. In some examples, the raised temperature may be a temperature of at least about 60° C., for example, at least about 61° C., at least about 62° C., at least about 63° C., at least about 64° C., at least about 65° C., at least about 66° C., at least about 67° C., at least about 68° C., at least about 69° C., at least about 70° C., at least about 71° C., at least about 72° C., at least about 73° C., at least about 74° C., at least about 75° C., at least about 76° C., at least about 77° C., at least about 78° C., at least about 79° C., or at least about 80° C. In some examples, the raised temperature may be a temperature of about 80° C. or less, for example, about 79° C. or less, about 78° C. or less, about 77° C. or less, about 76° C. or less, about 75° C. or less, about 74° C. or less, about 73° C. or less, about 72° C. or less, about 71° C. or less, about 70° C. or less, about 69° C. or less, about 68° C. or less, about 67° C. or less, about 66° C. or less, about 65° C. or less, about 64° C. or less, about 63° C. or less, about 62° C. or less, about 61° C. or less, or about 60° C. or less. In some examples, the raised temperature may be a temperature of from about 60° C. to about 80° C., for example, about 61° C. to about 80° C., about 62° C. to about 79° C., about 63° C. to about 78° C., about 64° C. to about 77° C., about 65° C. to about 76° C., about 66° C. to about 75° C., about 67° C. to about 74° C., about 68° C. to about 73° C., about 69° C. to about 72° C., or about 70° C. to about 71° C. In some examples, during heating, some or all of the solvent, if present, may evaporate.

In some examples, pressure is applied during contacting of the reworkeble optically clear adhesive composition with a substrate, for example, the optically clear panel and/or the light emitting panel. In some examples, a applied pressure is a pressure of at least about 15 kg/cm², for example, at least about 16 kg/cm², at least about 17 kg/cm², at least about 18 kg/cm², at least about 19 kg/cm², at least about 20 kg/cm², at least about 21 kg/cm², at least about 22 kg/cm², at least about 23 kg/cm², at least about 24 kg/cm², at least about 25 kg/cm², at least about 26 kg/cm², at least about 27 kg/cm², at least about 28 kg/cm², at least about 29 kg/cm², or at least about 30 kg/cm². In some examples, the applied pressure is a pressure of about 30 kg/cm² or less, for example, at least about 16 kg/cm², at least about 17 kg/cm², at least about 18 kg/cm², at least about 19 kg/cm², at least about 20 kg/cm², at least about 21 kg/cm², at least about 22 kg/cm², at least about 23 kg/cm², at least about 24 kg/cm², at least about 25 kg/cm², at least about 26 kg/cm², at least about 27 kg/cm², at least about 28 kg/cm², at least about 29 kg/cm², or at least about 30 kg/cm². In some examples, the applied pressure is a pressure of from about 15 kg/cm² to about 30 kg/cm², for example, about 16 kg/cm² to about 30 kg/cm², about 17 kg/cm² to about 29 kg/cm², about 18 kg/cm² to about 28 kg/cm², about 19 kg/cm² to about 27 kg/cm², about 20 kg/cm² to about 26 kg/cm², about 21 kg/cm² to about 25 kg/cm², about 22 kg/cm² to about 24 kg/cm², or about 23 kg/cm² to about 24 kg/cm².

In some examples, the method of producing a display for an electronic device may comprise applying a layer of a reworkable optically clear adhesive composition to the surface of a first substrate: and contacting the first substrate with a second substrate with the layer of optically clear adhesive composition therebetween, and checking the alignment of the first substrate with the second substrate. If the first substrate and the second substrate are misaligned, the method may comprise heating the display: separating the first substrate from the second substrate; repositioning the first substrate relative to the second substrate and contacting the first substrate with the second substrate with the layer of optically clear adhesive composition therebetween. This process may be referred to as reworking the adhesive composition.

### EXAMPLES

The following illustrates examples of the methods and other aspects described herein. Thus, these Examples should not be considered as limitations of the present disclosure, but are merely in place to teach how to make examples of the present disclosure.

### Example

To produce an example reworkable optically clear adhesive composition the following components are combined (percentages given as a weight percentage of the total composition, including volatile components):

(A) Hot melt adhesive: ethylene vinyl acetate 40 wt. %;

(B) Pressure sensitive adhesive: acrylic-based adhesive 20 wt %;

(C) Thickener: 0.5 wt. % polymethylmethacrylate;

(D) Surfactant: 0.3 wt. % sodium polyoxyethylene alkyl ether carboxylate;

(E) Solvent: 39.0 wt. % methyl ethyl ketone; and

(F) Biocide: 0.2 wt. % glutaraldehyde.

The combined components were mixed in a Rotosolver™ high shear mixer at a shear rate of 3,500 rpm and a temperature of 65° C.

To produce a display for an electronic device, the reworkable optically clear adhesive composition was applied by screen printing to a touchscreen to form a layer of the reworkable optically clear adhesive composition. The layer of reworkable optically clear adhesive composition was then heated to a temperature of 65° C. to evaporate the solvent and dry the layer of reworkable optically clear adhesive composition. The layer of reworkable optically clear adhesive was contacted with the surface of a light emitting panel. A pressure of 25 kg/cm² was applied, causing the touchscreen to adhere to the light emitting panel. The reworkable optically clear adhesive composition was then applied by screen printing to a protective panel to form a layer of the reworkable optically clear adhesive composition. The layer of reworkable optically clear adhesive composition was then heated to a temperature of 65° C. to evaporate the solvent and dry the layer of reworkable optically clear adhesive composition. The layer of reworkable optically clear adhesive was contacted with the surface of the touchscreen. A pressure of 25 kg/cm² was applied, causing the protective panel to adhere to the touchscreen. it is believed that the titanium dioxide nanoparticles diffuse the light as it passes through the reworkable optically clear adhesive composition, reducing the sparkling of the light emitted by the light emitting device. Since titanium dioxide particles are nanoparticles, this diffusion of light is not believed to obviously impact image resolution.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims. Unless otherwise stated, the features of any dependent claim can be combined with the features of any of the other dependent claims and any of the independent claims.

1. A reworkable optically clear adhesive composition comprising:
a hot melt adhesive present in an amount of at least about 40 wt. %;
a pressure sensitive adhesive present in an amount of at least about 10 wt. %; and
titanium dioxide nanoparticles present in an amount of up to about 5 wt. %;
wherein the weight percentage of each component is based on the total weight of solids of the adhesive composition.

2. The reworkable optically clear adhesive composition according to claim 1, wherein the composition is reworkable at a temperature in the range of from about 60° C. to about 80° C.

3. The reworkable optically clear adhesive composition according to claim 1, wherein the titanium dioxide nanoparticles have an average particle size of from about 1 nm to about 100 nm.

4. The reworkable optically clear adhesive composition according to claim 1, wherein the titanium dioxide nanoparticies are present in an amount of from about 0.1 wt. % to about 5 wt. % of the total weight of the solids of the adhesive composition.

5. The reworkable optically clear adhesive composition according to claim 1, wherein the weight ratio of the hot melt adhesive to the pressure sensitive adhesive is from about 2:3 to about 9:1.

6. The reworkable optically clear adhesive composition according to claim 1, wherein the hot melt adhesive is selected from ethylene vinyl acetate, polypropylene, polyimide, polyurethane and combinations thereof.

7. The reworkable optically clear adhesive composition according to claim 1, wherein the pressure sensitive adhesive is selected from acrylic-based adhesives, natural rubber-based adhesives, styrene-butadiene rubber based adhesives, styrenic block copolymer based adhesives, silicone-based adhesives, epoxy adhesives, polyurethane acrylate adhesives and combinations thereof.

8. A display for an electronic device comprising:
an optically clear panel;
a layer of a reworkable optically clear adhesive composition; and
a light emitting panel;
wherein the reworkable optically clear adhesive composition comprises:
a hot melt adhesive present in an amount of at least about 40 wt. %;
a pressure sensitive adhesive present in an amount of at least about 10 wt. %; and
titanium dioxide nanoparticles present in an amount of up to about 5 wt. %;
wherein the weight percentage of each component is based on the total weight of solids of the adhesive composition.

9. The display according to claim 8, wherein the titanium dioxide nanoparticles are present in an amount of from about 0.1 wt. % to about 5 wt. % of the total weight of the solids of the adhesive composition.

10. The display according to claim 8, wherein the reworkabie optically clear adhesive composition adheres the light emitting panel to the optically clear panel.

11. The display according to claim 8, wherein the light emitting panel comprises a liquid crystal display panel or a light emitting diode display panel.

12. The display according to claim 8, wherein the optically clear panel comprises a touchscreen, a protective panel or a combination thereof and/or wherein the light emitting panel comprises a touchscreen.

13. The display according to claim 8, wherein the optically clear panel comprises a touchscreen and a protective panel.

14. The display according to claim 13, wherein the layer of reworkable optically clear adhesive composition adheres the light emitting panel to the optically clear panel and the display comprises a further layer of the reworkable optically clear adhesive composition that adheres the touchscreen to the protective panel.

15. A method of producing a display for an electronic device comprising:
applying a layer of a reworkable optically clear adhesive composition to the surface of an optically clear panel and/or the surface of a light emitting panel; and
contacting the optically clear panel and the light emitting panel with the layer of reworkable optically clear adhesive composition therebetween;
wherein the reworkable optically clear adhesive composition comprises:
a hot melt adhesive present in an amount of at least about 40 wt. %;
a pressure sensitive adhesive present in an amount of at least about 10 wt. %; and
titanium dioxide nanoparticles present in an amount of up to about 5 wt. %;
wherein the weight percentage of each component is based on the total weight of solids of the adhesive composition
